(19) United States
(12) Patent Application Publication
(10) Pub. No.: US 2014/0358412 A1
(43) Pub. Date: Dec. 4, 2014

(54) Method for operating a driver assistance system and method for processing vehicle surroundings data

(71) Applicants: Michael Fausten, Asperg (DE); Andreas Reppich, Leonberg (DE)

(72) Inventors: Michael Fausten, Asperg (DE); Andreas Reppich, Leonberg (DE)

(21) Appl. No.: 14/348,474

(22) PCT Filed: Aug. 24, 2012
(86) PCT No.: PCT/EP2012/066509

§ 371 Date: Jul. 7, 2014

(30) Foreign Application Priority Data
Oct. 11, 2011 (DE) 102011084275.6

(51) Int. Cl. G08G 1/16; G08G 1/0967

(52) U.S. Cl. CPC G08G 1/16; G08G 1/0967
USPC 701/117

(57) ABSTRACT

A method for operating a driver assistance system of a vehicle including the following: detecting a vehicle surroundings, transmitting vehicle surroundings data corresponding to the detected vehicle surroundings to a server, evaluating the transmitted vehicle surroundings data with the aid of the server, characterized by a transmission of a result corresponding to the evaluated vehicle surroundings data to the vehicle to operate the driver assistance system as a function of the result. Also described is a method for processing vehicle surroundings data, and a corresponding systems and computer program.

### FIELD OF THE INVENTION

The present invention relates to a method and a system for operating a driver assistance system. The present invention also relates to a method and a system for processing vehicle surroundings data. In addition, the present invention relates to a computer program.

### BACKGROUND INFORMATION

A method for generating a geographic database is discussed in patent specification EP 0 921 509 B1. In this method multiple vehicles sensorily detect corresponding vehicle surroundings and transmit the resulting data to a central database. The database is then updated based on these vehicle surroundings data.

### SUMMARY OF THE INVENTION

An object of the present invention may be seen in providing an improved method for operating a driver assistance system of a vehicle.

The object of the present invention may also be seen in providing a corresponding system for operating a driver assistance system of a vehicle.

The object of the present invention may also be seen in providing an improved method and a system for processing vehicle surroundings data.

The object of the present invention may also be seen in providing a corresponding computer program.

multiple sets of vehicle surroundings data. The evaluation unit is also configured to form a set of reference data or reference route data based on the evaluated sets of vehicle surroundings data.

According to yet another aspect, a computer program is provided which includes program code for carrying out the method for operating a driver assistance system and/or the method for processing vehicle surroundings data if the computer program is run on a computer.

Thus, the present invention incorporates in particular the concept of detecting a vehicle surroundings with the aid of a driver assistance system. For this purpose, the driver assistance system has in particular one or multiple sensors which are identically or differently configured. For example, the sensors may be radar sensors or ultrasound sensors. For example, the sensors may also be video sensors of a video camera. The vehicle surroundings data resulting from the detected vehicle surroundings are then transmitted to a server. Such a server may be an external server. External is understood here in particular to mean the area outside the vehicle. Hence, this means that such an external server is situated outside the vehicle.

The server evaluates the transmitted vehicle surroundings data and subsequently transmits a result corresponding to the evaluated vehicle surroundings data back to the vehicle. The driver assistance system is then advantageously operated, in particular controlled, as a function of the result.

Because an evaluation of vehicle surroundings data is carried out by an external server, a possibly present evaluation unit of the driver assistance system may be configured to be weaker in terms of its computational power. Moreover, additional and more comprehensive and, in particular, up-to-date algorithms are available on the server for evaluating the vehicle surroundings data as compared to the evaluation algorithms implemented during the manufacture of the driver assistance system. Hence, an improved evaluation of vehicle surroundings data may be advantageously achieved in this way. Moreover, an external server generally has access to additional data sources, for example, the server has access to vehicle surroundings data transmitted from other vehicles. This additional information may then also advantageously be taken into account during the evaluation so that a result adapted to the corresponding situation may be generated which is then transmitted to the vehicle.

In addition, the driver assistance system may be provided with new functionalities as a result of outsourcing the evaluation to the server. For example, a driver assistance system initially configured to apply the brakes at an increased speed in a turn may now also be configured to correspondingly adapt a light cone of the headlights to the curvature of the turn.

The present invention also incorporates the concept of receiving multiple sets of vehicle surroundings data. In this case, it may be provided that the multiple sets have been transmitted to an external server from different vehicles. The server evaluates the multiple sets of vehicle surroundings data in order to form from these a set of reference route data. These reference route data may then be made available or provided to the vehicles. For example, a driver assistance system may then be advantageously operated, in particular controlled, based on the set of reference route data. Hence, the driver assistance system receives not only its own detected sensor data, but also corresponding vehicle surroundings data of other vehicles as a basis for deciding whether to intervene in a driving operation. These vehicles may in particular have more accurate or more up-to-date vehicle surroundings data provided to the server, so that the resultant set of reference route data formed therefrom is more accurate and more up-to-date than the proprietary set of vehicle surroundings data. This advantageously allows for improved operation and control of the driver assistance system. Vehicle safety is also advantageously enhanced in this way.

Vehicle surroundings data within the meaning of the present invention include, in particular, information about physical features or characteristics of the route, for example the curvature of a turn, an uphill grade, a down-grade, a number of lanes, lane widths. Vehicle surroundings data include, in particular, information about physical or material objects which are situated next to, at, or on the route such as, for example, traffic signs, boundary posts or signaling systems. The vehicle surroundings data are associated in particular with a respective vehicle surroundings position which includes in particular information on the position at which the physical feature or characteristic or the physical objects are located. Such a position may, for example, also be delineated in relation to a digital map.

Since reference route data were formed based on the vehicle surroundings data, the reference route data also include, in particular, the corresponding information about physical features or characteristics of the route and/or information about physical or material objects. In this respect, these reference route data advantageously constitute a reference to which the vehicles may resort to.

According to one specific embodiment, the vehicle surroundings data are transmitted to the server in response to a situation threshold value assigned to a driving situation. A situation threshold value within the meaning of the present invention includes, in particular, information about a particular situation in which the vehicle presently finds itself. In this respect, the situation threshold value describes the corresponding vehicle situation. Only when the situation threshold value exceeds a certain predefined value, for example, are the vehicle surroundings data transmitted to the server for the purpose of evaluation. Otherwise, it may be provided that the vehicle surroundings data are evaluated in the driver assistance system itself and are not transmitted to the server. Thus, an evaluation of the vehicle surroundings data appropriate to the situation may be advantageously carried out, making an even more efficient operation of a driver assistance system possible. In this way, for example, electrical energy is saved if the vehicle surroundings data are not transmitted to the server, but are instead evaluated locally by the driver assistance system itself.

A situation may, for example, be described as follows. A vehicle is situated before a turn. A number of other vehicles are ahead of the vehicle. Another situation may, for example, be described as follows: The vehicle is situated on a multi- lane road having no boundary posts. In particular, it may be provided that the vehicle surroundings data are transmitted to the server once the situation reaches a certain degree of complexity.

According to another specific embodiment, the result includes a control signal for a vehicle component which may be controlled with the aid of the driver assistance system. In particular, this means that in such a case the external server may control the driver assistance system. In this way, for example, a reaction time of the driver assistance system may be advantageously reduced as compared to the case in which a result is merely transmitted to the driver assistance system, since here the driver assistance system, based on the result, would have to independently generate corresponding control signals for the individual vehicle components. A vehicle component may include, for example, a drive system, a braking system, a steering system, a suspension system and/or a light system. The vehicle component may, in particular, also be a transmission control, actuators, a signaling system, a lighting control, a braking system, a brake modulation system or a vehicle guidance system. Multiple vehicle components may also be provided which may in particular be identical or may vary in configuration.

According to one specific embodiment, the evaluation of multiple sets of vehicle surroundings data includes aggregating the vehicle surroundings data. An aggregation means, in particular, that the vehicle surroundings data are arranged in groups in order to advantageously display them more clearly and to facilitate their interpretation. In addition, a corresponding further evaluation of such aggregated data is also facilitated, thereby making an efficient evaluation possible in this case.

According to one specific embodiment, the evaluation may include a linking of vehicle surroundings data from one measurement with vehicle surroundings data from another measurement. The vehicle surroundings data may be provided in this case with corresponding weighting factors. Based on the linked vehicle surroundings data, it is then possible to ascertain, in particular, consolidated measured values which are then used to form the reference data.

According to another specific embodiment the evaluation includes averaging the vehicle surroundings data. This means, for example, that when a physical object is assigned different positions, an averaging of the multiple positions is carried out so that in the set of reference route data this physical object is assigned an averaged position. The vehicle surroundings data may be weighted prior to averaging, i.e., provided in particular with a weighting factor.

According to still one further specific embodiment, it may be provided that the evaluation includes assigning the vehicle surroundings data a sensor weighting factor as a function of a sensor quality factor associated with a sensor of a driver assistance system. A sensor quality factor may, for example, include the information as to the type or kind of sensor, whether, for example, it is a radar or ultrasound sensor, or what range the sensor has. The vehicle surroundings data therefore include in particular the aforementioned information. Thus, depending on the information, the vehicle surroundings data are assigned a sensor weighting factor, the evaluation then also being carried out based in particular on the sensor weighting factor. Thus, in the evaluation it may be taken into consideration, in particular, whether the vehicle surroundings data correspond to vehicle surroundings which have been detected with the aid of a long-range radar sensor or with the aid of a short-range ultrasound sensor or with the aid of the sensor system described below. An evaluation and, in that respect, formation of the set of reference route data are therefore improved significantly.

According to one other specific embodiment, a sensor system for detecting the vehicle surroundings may be provided which may sensorily detect vehicle surroundings and, in particular, form corresponding sensor data. Such a sensor system may include, for example, a video sensor, in particular a stereo video sensor. A sensor system may advantageously include a 3D camera. According to one further specific embodiment, it may be provided that the sensor system may include a 360° camera, also referred to as a “surround camera.” The sensor system may, for example, also include a lidar sensor and/or a radar sensor and/or an ultrasound sensor. The sensor system may include a time-of-flight (TOF) sensor. Such a sensor may be used in particular for measuring distance using a transit time method. In particular, the surroundings sensor system may also include a photomix detector (PMD). Such a photomix detector sensor is also called a “photonic mixer device”-sensor. Since the sensor system sensorily detects vehicle surroundings in particular, it may also be referred to, for example, as a surroundings sensor system.

In one further specific embodiment, the evaluation may include a linking of the vehicle surroundings data assigned the one sensor weighting factor to other vehicle surroundings data assigned another sensor weighting factor. In particular, this means therefore that vehicle surroundings data formed with the aid of a sensor are linked to the other vehicle surroundings data formed with the aid of the other sensor.

In one further specific embodiment it may be provided that the evaluation includes assigning the vehicle surroundings data a time weighting factor as a function of a time attribute associated with the vehicle surroundings data. A time attribute within the meaning of the present invention includes, in particular, the information as to when the vehicle surroundings data were formed or when the vehicle surroundings were sensorily detected. In the evaluation, it may then be provided that the chronologically more recent vehicle surroundings data receive stronger consideration than the chronologically older vehicle surroundings data. A set of reference route data formed in this way is therefore advantageously up-to-date.

According to one further specific embodiment, it may be provided that the system for operating a driver assistance system and the system for processing vehicle surroundings data form a common system. This means, in particular, that the corresponding evaluation unit, the transmitter and the receiver provide both functionalities of the respective systems.

The present invention is explained in greater detail below based on exemplary embodiments with reference to the figures. The same reference numerals are used below for the same features.

### BRIEF DESCRIPTION OF THE DRAWINGS

FIG. 1 shows a system for operating a driver assistance system.

FIG. 2 shows a vehicle having a driver assistance system and the system from FIG. 1.

FIG. 3 shows a system for processing vehicle surroundings data.

FIG. 4 shows multiple vehicles each having a driver assistance system and the system from FIG. 3.

FIG. 5 shows a flow chart of a method for operating a driver assistance system of a vehicle.

FIG. 6 shows a flow chart of a method for processing vehicle surroundings data.

### DETAILED DESCRIPTION

FIG. 1 shows a system 101 for operating a driver assistance system (not shown) of a vehicle (not shown). System 101 includes a receiver 103 for receiving vehicle surroundings data. System 101 further includes an evaluation unit 105 which is able to evaluate the received vehicle surroundings data.

Also provided is a transmitter 107 which is able to transmit a result corresponding to the evaluation to a vehicle in order to operate the driver assistance system as a function of the result.

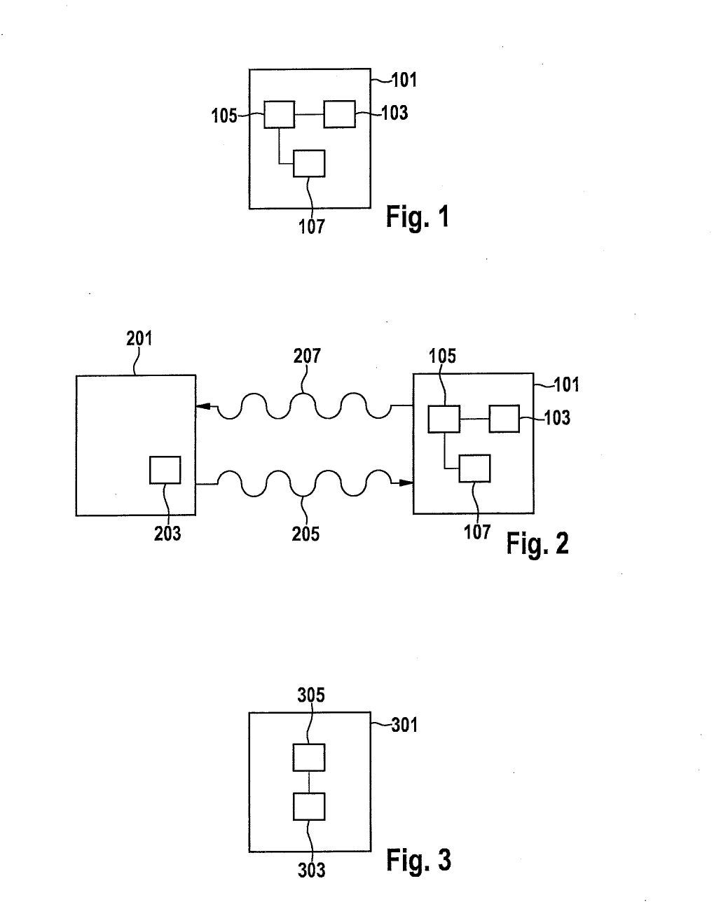

FIG. 2 shows a vehicle 201 having a driver assistance system 203. With the aid of driver assistance system 203 vehicle surroundings are sensorily detected. Radar, ultrasound and/or video sensors may be provided for this purpose. The correspondingly formed vehicle surroundings data are transmitted to system 101. This transmitting is represented symbolically by a wavy arrow with the reference numeral 205.

System 101 evaluates the transmitted vehicle surroundings data with the aid of evaluation unit 105. A result is transmitted by transmitter 107 to driver assistance system 203. This transmission is represented symbolically in FIG. 2 by a wavy arrow with the reference numeral 207. Vehicle 201 includes in particular a transmitter and a receiver not shown here for transmitting the vehicle surroundings data and for receiving the result.

Because an evaluation of the vehicle surroundings data is advantageously carried out externally of driver assistance system 203, this allows further developed algorithms for evaluation to be used for this purpose, which may then advantageously add new functionalities to the driver assistance system which it did not yet have at the time of manufacture.

FIG. 3 shows a system 301 for processing vehicle surroundings data. System 301 includes a receiver 303 for receiving multiple sets of vehicle surroundings data. System 301 also includes an evaluation unit 305 for evaluating multiple sets of vehicle surroundings data, evaluation unit 305 also being configured to form a set of reference route data based on the evaluated sets of vehicle surroundings data.

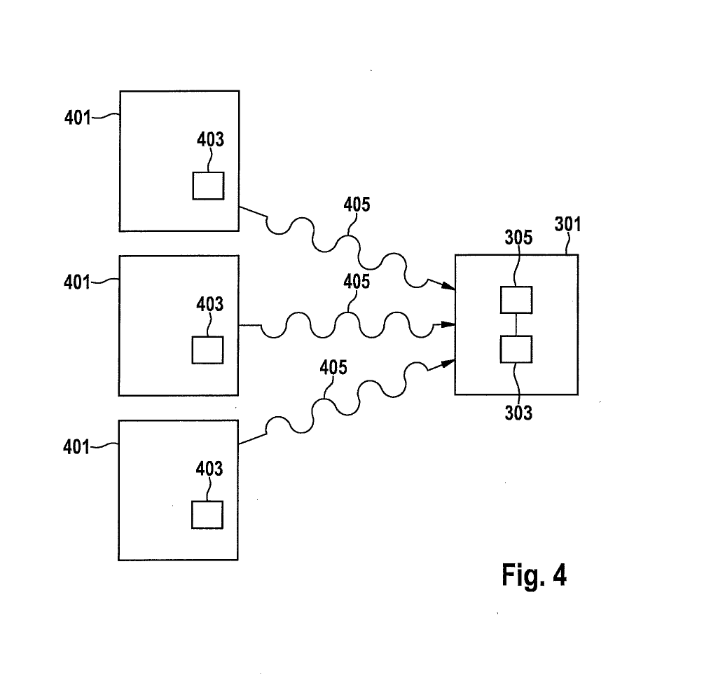

FIG. 4 shows multiple vehicles 401, each having a driver assistance system 403. With the aid of a corresponding sensor system such as, for example, video, radar and/or ultrasound sensors of the driver assistance system 403, the vehicle surroundings are sensorily detected and corresponding vehicle surroundings data are transmitted to system 301. This transmission is represented symbolically here by a wavy arrow with reference numeral 405. Evaluation unit 305 of system 301 evaluates the multiple sets of vehicle surroundings data, and based on these, forms a set of reference route data. These reference route data may then be provided in particular to vehicles 401 in order in particular in response thereto to operate, in particular to control, respective driver assistance system 403. Here too, corresponding receivers and transmitters, which for the sake of clarity are not shown, may also be provided in vehicles 401 for communication between vehicles 401 and system 301.

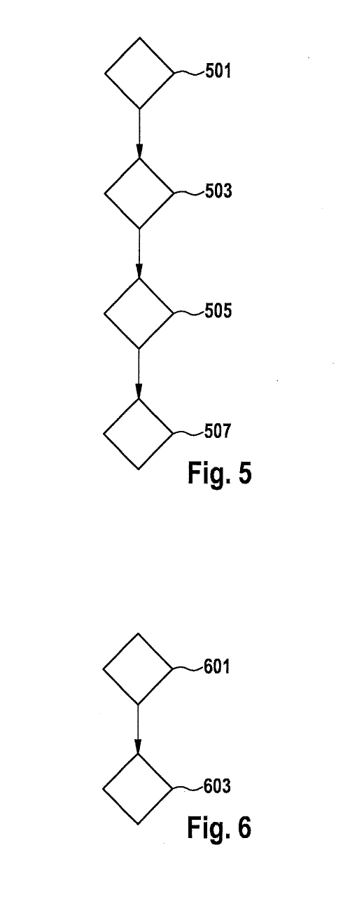

FIG. 5 shows a flow chart of a method for operating a driver assistance system of a vehicle. In a step 501 vehicle surroundings are detected. In a step 503 vehicle surroundings data corresponding to the detected vehicle surroundings are transmitted to a server. According to a step 505, the transmitted vehicle surroundings data are evaluated with the aid of the server. In a step 507 a result corresponding to the evaluated vehicle surroundings data is transmitted to the vehicle in order to operate the driver assistance system of the vehicle as a function of the result.

FIG. 6 shows a flow chart of a method for processing vehicle surroundings data. In a step 601 the multiple sets of vehicle surroundings data are received. The multiple sets of vehicle surroundings data are evaluated in a step 603 in order to form a set of reference route data. In this case it may in particular be provided that the evaluation includes an aggregation of vehicle surroundings data. The evaluation may also include an averaging of the vehicle surroundings data.

In summary therefore, the present invention incorporates in particular the concept of connecting sensors, in particular surroundings sensors, of a driver assistance system via a data connection to an external server. Thus, in particular situations the surroundings sensor system may advantageously pose a query to the external server. Transmitted with this query to the external server are suitable object and situation data, notably the vehicle surroundings data. The external server may then evaluate the data using up-to-date algorithms and/or match them with database information. The result is then transmitted back to the surroundings sensors or to the surroundings sensor system in order to appropriately operate, in particular control, the driver assistance system.

This has in particular two essential advantages.

On the one hand, the data transmitted to the external server are available as a database for further development and validation of functions and algorithms.

On the other hand, the vehicle owner in particular profits from the sensor system and the driver assistance system functions in the vehicle which are further developed and updated over the service life, as well as from the situational data, i.e., notably vehicle surroundings data of other users and/or vehicles which the owner may then utilize for his driver assistance system functions.

According to one further specific embodiment, it may be provided that algorithmic updates and/or data updates, after being successfully validated in the server, are transmitted to the sensor which includes in particular a control device for controlling a vehicle component, in order in particular to advantageously update an appropriate software in the driver assistance system.

In one further specific embodiment, it may be provided that the communication between a driver assistance system and a system for operating a driver assistance system and/or a system for processing vehicle surroundings data is carried out with the aid of mobile data transmission methods such as, for example, Long Term Evolution (LTE) or in particular also future mobile data transmission methods, in particular data transmission methods which are based on the LTE method. The data transmission may be encrypted.

In one further specific embodiment, it may be provided that when it is determined that the evaluation was unsuccessful, the vehicle surroundings data of a second database are added for development purposes and/or if necessary an error message in particular is transmitted to the sensor. If within the scope of further development of the relevant driver assistance system function an answer is found, the data set with the answer is transmitted to the appropriate knowledge database of the server and, if necessary, the evaluation algorithms are updated.

Data may be transmitted, for example, via an interface to a mobile radio terminal in the vehicle, for example a cell phone having a suitable program, in particular, a suitable app. However, it may also be provided that in addition or instead, the sensor architecture installed in the vehicle, i.e., in particular, the sensor system of the driver assistance system, may have its own mobile radio device, if necessary, in particular with its own SIM card.

1-12. (canceled)

13. A method for operating a driver assistance system of a vehicle, the method comprising:
detecting a vehicle surroundings;
transmitting vehicle surroundings data corresponding to the detected vehicle surroundings to a server;
evaluating the transmitted vehicle surroundings data with the aid of the server; and
transmitting a result corresponding to the evaluated vehicle surroundings data to the vehicle for operating the driver assistance system as a function of the result.

14. The method of claim 13, wherein the vehicle surroundings data are transmitted to the server in response to a situation threshold value assigned to a driving situation.

15. The method of claim 13, wherein the result includes a control signal for a vehicle component which is controllable with the aid of the driver assistance system.

16. The method of claim 15, wherein the vehicle component is a drive, a transmission control, actuators, a signaling system, a vehicle guidance system, a braking system, a brake modulation system or a lighting control.

17. A method for processing vehicle surroundings data, the method comprising:
receiving multiple sets of vehicle surroundings data; and
evaluating the multiple sets of vehicle surroundings data to form a set of reference route data.

18. The method of claim 17, wherein the evaluation includes an aggregation of the vehicle surroundings data.

19. The method of claim 17, wherein the evaluation includes a linking of the vehicle surroundings data to additional vehicle surroundings data and/or an averaging of the vehicle surroundings data.

20. The method of claim 17, wherein the evaluation includes assigning the vehicle surroundings data a sensor weighting factor as a function of a sensor quality factor assigned to a sensor of a driver assistance system.

21. The method of claim 17, wherein the evaluation includes assigning the vehicle surroundings data a time weighting factor as a function of a time attribute assigned to the vehicle surroundings data.

22. A system for operating a driver assistance system of a vehicle, comprising:
a receiver to receive vehicle surroundings data transmitted from the vehicle;
an evaluation unit to evaluate the vehicle surroundings data; and
a transmitter to transmit a result corresponding to the evaluation to the vehicle for operating the driver assistance system as a function of the result.

23. A system for processing vehicle surroundings data, comprising:
a receiver to receive multiple sets of vehicle surroundings data; and
an evaluation unit to evaluate the multiple sets of vehicle surroundings data and to form a set of reference route data based on the evaluated sets of vehicle surroundings data.

24. A computer readable medium having a computer program, which is executable by a processor, comprising:
a program code arrangement having program code for operating a driver assistance system of a vehicle, by performing the following:
detecting a vehicle surroundings;
transmitting vehicle surroundings data corresponding to the detected vehicle surroundings to a server;
evaluating the transmitted vehicle surroundings data with the aid of the server; and
transmitting a result corresponding to the evaluated vehicle surroundings data to the vehicle for operating the driver assistance system as a function of the result.
